(19) United States
(12) Patent Application Publication
(10) Pub. No.: US 2013/0331159 A1
(43) Pub. Date: Dec. 12, 2013

(54) GAME MACHINE AND METHOD OF GENERATING SENSOR CORRECTION DATA THEREFOR

(71) Applicant: Konami Digital Entertainment Co., Ltd., Tokyo (JP)

(72) Inventors: Kenta Ito, Minato-ku (JP); Tetsuo Ishida, Minato-ku (JP)

(21) Appl. No.: 13/905,768

(22) Filed: May 30, 2013

(30) Foreign Application Priority Data
Jun. 6, 2012 (JP) 2012-128955

(51) Int. Cl. A63F 13/00

(52) U.S. Cl. CPC A63F 13/00
USPC 463/6

(57) ABSTRACT

A game machine which comprises: a self-propelling vehicle as a traveling body capable of traveling on a travel surface; and a sensor capable of outputting an output signal corresponding to a change of physical state of each of cell portions arranged two-dimensionally along the travel region, the physical state changing depending on positional relation to the self-propelling vehicle, and detects the position of self-propelling vehicle based on the output signal by the sensor, wherein the travel surface is sectioned into plural regions, and when each region changes from a region where the self-propelling vehicle exists to a vacant region where no self-propelling vehicle exists in relays the output signal by the sensor relating to the vacant region is obtained, and the output signal of each vacant region obtained is combined together to generate correction data for the sensor.

### CROSS REFERENCE TO RELATED APPLICATION

This application claims priority to Japanese Patent Application No. 2012-128955, filed Jun. 6, 2012, the disclosure of which is hereby incorporated by reference in its entirety.

### TECHNICAL FIELD

The present invention relates to a game machine that makes a traveling body travel along a predetermined travel region.

### BACKGROUND ART

There is known a game machine configured so that a field is provided at an upper surface side of a top plate of its chassis, a plurality of models representing racehorses and the like are arranged on the field, a section plate is provided below the top plate of the chassis to make space, a plurality of traveling bodies capable of self-propelling are arranged within the space, and by coupling the traveling body and the model through the top plate by magnetic force, the model can travel following the traveling body. For this type of game machine, it is necessary to sequentially detect the position of traveling body in order to control the travel of traveling body. In order to solve this problem, suggested is a game machine using an electromagnetic coupling type of sensor to detect the position of traveling body, the sensor being configured in such a way that a sheet-like detection portion where transmitting-side coils and receiving-side coils are arranged so as to be perpendicular to each other, is laid on all over the travel surface of the traveling body, and used is change of electromagnetic coupling between the coils, the change being provoked by approach of an electronic conductor, such as metal piece, provided to the traveling body to the coils (for example, the Patent Literature 1).

Patent Literature PTL1 : JP-A-2011-188906.

### SUMMARY OF INVENTION

### Technical Problem

In a case of the sensor above mentioned, various kinds of components including the electric conductor, such as metal, are arranged on the travel surface of the traveling body or around the travel surface, and those components could affect a state of electromagnetic coupling of one portion of cell portions. For excluding the affection to improve the position detection accuracy of traveling body, it is necessary to obtain output from the sensor in a state that the traveling bodies are removed from the travel surface and generate correction data; and to correct in reference to the correction data, output from the sensor, the output being obtained while the traveling body is traveling. However, in order to remove the traveling body, it is necessary to disassemble the chassis. Further, in order to generate the correction data accurately, it is necessary to assemble the chassis in a state that the traveling body does not exist. Such operations are troublesome.

Then, the aim of the present invention is providing a game machine and a method of generating sensor correction data capable of generating accurate correction data of a sensor in a state that a traveling body is maintained at the travel region.

### Solution to Problem

A game machine as one aspect of the present invention is a game machine comprising: a traveling body capable of traveling along a predetermined travel region; a sensor capable of outputting an output signal corresponding to a change of physical state of each of a plurality of cell portions which are arranged two-dimensionally along the travel region, the physical state changing depending on positional relation to the traveling body; and a position detecting device that is configured to detect a position of the traveling body based on the output signal by the sensor, wherein the game machine further comprising a correction data generating device that is configured to when each of a plurality of regions, which the travel region is sectioned into, changes from a region where the traveling body exists to a vacant region where no traveling body exists in relays, obtain output signal by the sensor relating to the vacant region, and generate correction data for the output signal relating to a whole of travel region by combining together the output signal of each vacant region obtained.

Further, a method of generating sensor correction data as one aspect of the present invention is a method of generating sensor correction data of a game machine comprising: a traveling body capable of traveling along a predetermined travel region; a sensor capable of outputting an output signal corresponding to a change of physical state of each of a plurality of cell portions which are arranged two-dimensionally along the travel region, the physical state changing depending on positional relation to the traveling body; and a position detecting device that is configured to detect a position of the traveling body based on the output signal by the sensor, the method including the steps of: obtaining output signal by the sensor relating to a vacant region where no traveling body exists, when each of a plurality of regions, which the travel region is sectioned into, changes from a region where the traveling body exists to the vacant region in relays, and generating correction data for the output signal relating to a whole of travel region by combining together the output signal of each vacant region obtained.

According to the present invention, the travel region is sectioned into a plurality of regions, and in a case that each region becomes the vacant region, the output signal relating to the vacant region as a target is obtained. Since the vacant region is a region where no traveling body exists, the output signal by the sensor relating to the vacant region is equivalent to the output signal by the sensor at the moment when change of physical state corresponding to the traveling body does not occur. Accordingly, if the output of sensor at the moment when each of the plurality of regions becomes the vacant region is combined together, namely, each output of sensor is pieced together in accordance with positional relation of each region, it is possible to obtain output data substantially equivalent to output by the sensor obtained when the traveling body is removed from whole of the travel region. Since output relating to a region where the traveling body exists is not used for the combination to obtain the correction data, it is possible to generate accurate correction data even in a state that the traveling body remains at a portion of the travel region.

The game machine according to one embodiment of the present invention may further comprise a traveling body controlling device that is configured to control operations of the traveling body so as to calculate an aim position of the traveling body and make the traveling body to travel to the aim position, wherein the correction data generating device may be configured to obtain the output signal by the sensor relating to the vacant region when any one of the plurality of regions becomes the vacant region, as a result of control by the traveling body controlling device to operate the traveling body for an aim other than an aim to generate the correction data. According to this embodiment, in process of controlling operations of the traveling body for an aim other than an aim to generate the correction data, for example an aim to progress a game, when any one of the plurality of regions becomes the vacant region as a result of the control, output signal by the sensor relating to the vacant region is obtained by the correction data generating device. While operation of traveling body is repeated, output by the sensor obtained when each of the plurality of regions becomes the vacant region is generally gathered. By combining the outputs gathered, it is possible to generate the correction data relating to whole of the travel region. In this case, it is possible to reduce or eliminate need to control operations of the traveling body to make the vacant region for an aim to generate the correction data. Thereby, it is possible to generate the correction data while avoiding influence on progress of the game.

The game machine according to one embodiment of the present invention may further comprise a traveling body controlling device that is configured to control operations of the traveling body so as to calculate an aim position of the traveling body and make the traveling body to travel to the aim position, wherein the traveling body controlling device may further comprises a traveling body position setting device that is configured to control operations of the traveling body so that each of the plurality of regions becomes the vacant region in series for an aim to generate the correction data, and the correction data generating device may be configured to obtain the output signal by the sensor relating to each vacant region, each time when the vacant region switches by control of the traveling body position setting device. According to this embodiment, by controlling intentionally operations of the traveling body using the traveling body position setting device, it is possible to set in series each of the plurality of regions as the vacant region and obtain sequentially the output by the sensor relating to each vacant region. Thereby, it is possible to obtain efficiently the correction data of whole of travel region.

The game machine according to one embodiment of the present invention may further comprise a chassis including a top plate and a section plate provided at a lower surface side of the top plate so as to make space, wherein an upper surface of the section plate may be set as the travel region of the traveling body, and the plurality of cell portions of the sensor may be arranged two-dimensionally along the upper surface of the section plate. According to this embodiment, it is possible to obtain accurate correction data even in a state that the traveling body remains in a space between the top plate and section plate of the chassis. Therefore, it is possible to perform the effect of the present invention more usefully.

In the above embodiment, a plurality of self-propelling vehicles capable of traveling along the upper surface may be arranged as the traveling body, and on an upper surface of the top plate, a plurality of models coupled with the plurality of self-propelling vehicles may be arranged respectively so that each of the plurality of models travels on the upper surface of the top plate following travel of the traveling body. According to this embodiment, it is possible to generate the correction data for the sensor without removing the self-propelling vehicle from the chassis, in a game machine a type of which moves each model on the top plate by making the model to follow the self-propelling vehicle arranged below the top plate.

In the above embodiment having the travelling body controlling device, the game machine may further comprise a chassis including a top plate and a section plate provided at a lower surface side of the top plate so as to make space, wherein an upper surface of the section plate may be set as the travel region of the traveling body, the plurality of cell portions of the sensor may be arranged two-dimensionally along an upper surface of the section plate, on the upper surface of the section plate, a plurality of self-propelling vehicles capable of traveling along the upper surface may be arranged as the traveling body, on an upper surface of the top plate, a plurality of models coupled with the plurality of self-propelling vehicles may be arranged respectively so that each of the plurality of models travels on the upper surface of the top plate following travel of the traveling body, and the traveling body controlling device may be capable of calculating an aim position of each of the plurality of self-propelling vehicles so that progressed is a race game where each of the plurality of models is made to compete with each other. According to this embodiment, in process of control of the operation of self-propelling vehicle by the traveling body in order to progress a race game, it is possible to obtain the output by the sensor relating to the vacant region in parallel to the control. Alternatively, it is possible to generate the correction data by making the vacant region in series at the time different from the time when the traveling body controlling device is controlling operations of the self-propelling body in order to progress the race game.

In a case the upper surface of section plate is sectioned into a first region and a second region as the plurality of regions, the traveling body controlling device may control operations of each self-propelling vehicle so that a first state that the plurality of self-propelling vehicles gathers in the first region and a second state that the plurality of self-propelling vehicles gathers in the second region occur selectively, and the correction data generating device may set, while setting the second region as the vacant region in the first state and obtaining the output signal by the sensor relating to the second region, the first region as the vacant region in the second state and obtain the output signal by the sensor relating to the first region, and combine the output signal by the sensor relating to the first region and the output signal by the sensor relating to the second region to generate the correction data. According to this embodiment, it is possible to generate the correction data of whole of the travel region by combining the output by the sensor relating to the second region obtained in the first state and the output by the sensor relating to the first region obtained in the second state.

In one embodiment of the present invention, the traveling body may be provided with a detected body using electric conductor, and the sensor may be capable of outputting a signal corresponding to change of state of electromagnetic coupling provoked by approach of the electric conductor to each of the plurality of cell portions, as the signal corresponding to the change of the physical state. In this case, by the present invention it is possible to generate the correction data representing accurately influence of the electric conductor other than the detected body existing within the travel region or a periphery of the travel region.

### EFFECTS OF INVENTION

As mentioned above, the present invention sections the travel region into a plurality of regions, and each time when each region changes to the vacant region in relays, that is, in series, obtains the output by the sensor relating to the vacant region. Then, by combining the output by the sensor relating to each vacant region together, the present invention can generate correction data substantially equivalent to output by the sensor obtained when the traveling body is removed from whole of travel region.

### BRIEF DESCRIPTION OF DRAWINGS

FIG. 1 is a perspective view showing an external appearance of a game machine according to one embodiment of the present invention

FIG. 2 is a perspective view showing a state that major portions of a filed unit and a monitor unit are shown by removing the station units from the game machine

FIG. 3 is a perspective view showing a major portion of a chassis

FIG. 4 is a perspective view showing an internal construction of the chassis

FIG. 5 is a diagram showing an example of model and self-propelling vehicle

FIG. 6 is a perspective view showing an outline construction of a sensor provided on a travel surface of the self-propelling vehicle

FIG. 7 is a diagram showing installation structure of the sensor

FIG. 8 is a diagram showing expanded major portion of FIG. 7

FIG. 9 is a partial vertical sectional view showing a positional relation between the chassis of the game machine and the station unit

FIG. 10 is a diagram for explaining an outline of procedures of generating the correction data of sensor

FIG. 11 is a functional block diagram showing mainly a portion of a control system of game machine, the portion relating to the generation of correction data

FIG. 12 is a flowchart showing procedures of correction data generating process implemented by the correction data generating portion shown in FIG. 11

FIG. 13 is a flowchart showing a variation of the flowchart shown in FIG. 12.

### DESCRIPTION OF EMBODIMENTS

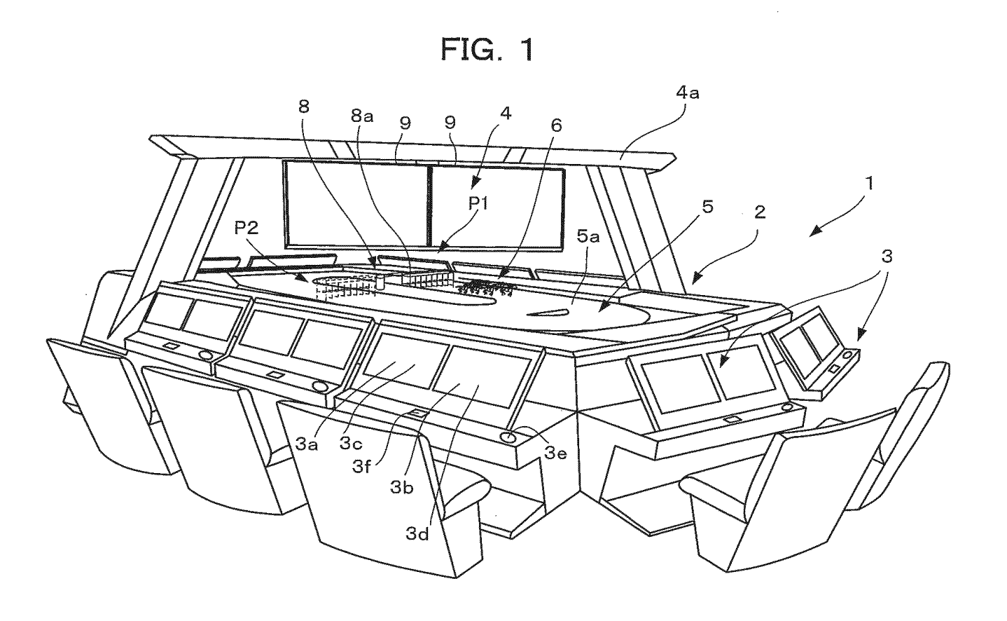

FIG. 1 shows an overall view of a game machine according to one embodiment of the present invention. The game machine 1 is configured as a game machine for commercial use (business use) which is installed to a facility such as a store, and allows a player, in exchange of payment of a game-play fee, to play a game in a range corresponding to the game-play fee. The game machine 1 is a so-called medal game machine using medals as game media.

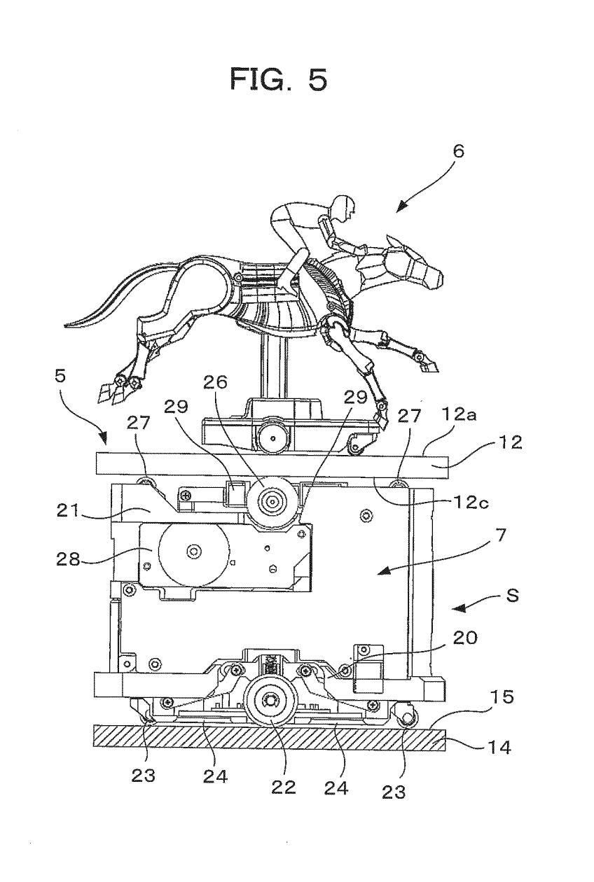

The game machine 1 comprises: a field unit 2; a plurality of station units 3 arranged so as to surround the field unit 2; and a monitor unit 4 arranged so as to be adjacent to the field unit 2. A field 5 is provided on an upper surface side of the field unit 2. In the field 5, played is a race horse game where each of plural models 6 representing racehorses is made to run within an oval-shaped course 5a to compete for its arrival order. As shown in FIG. 5 as one example, the model 6 is coupled by electromagnetic power with a self-propelling vehicle (a traveling body) 7 capable of traveling on a travel surface 15 provided to the inside of the field unit 2. Thereby, the model 6 travels on the field 5 following the self-propelling vehicle 7. The details of self-propelling vehicle 7 will be described later. A center portion of the field 5 is provided with a gate unit 8. The gate unit 8 has a gate 8a to align the models 6 before a race. The gate 8a can move selectably to one of the following positions: a position which is housed in the center of the field 5, a position P1 which intersects the course 5a in one side of the field 5, and a position P2 which interests the course 5a in the other side of the field 5.

The station unit 3 is provided as a terminal apparatus for allowing a player to participate in the game executed in the field 5. The station unit 3 is provided with a first monitor 3a and a second monitor 3b; and a first touch panel 3c and a second touch panel 3d which are transparent and overlapped on the surfaces of the first monitor 3a and the second monitor 3b respectively, a medal input slot 3e which accepts input of medals, and a card reader 3f which reads a card (not illustrated) possessed by a player to output a signal corresponding to the information read out of the card. At each station unit 3, one or two players can play the game. Each of the touch panels 3c, 3d is a known input device that outputs the signal depending on a position touched by a player with his/her finger. When some medals are input into the medal input slot 3e, the medals input are converted into credits which can be used in the hose race game. The credits are expended and paid out depending on the game content. The card read by the card reader 3f is provided with a non-volatility memory medium (not illustrated) such as an IC chip and a magnetic stripe. In the medium, an ID unique for each card (hereinafter, sometimes referred to as “the card ID”) is recorded. Incidentally, the card ID may be recorded to a card in form of a bar code or the like. Alternatively, in exchange of a card, the card ID may be recorded in the memory medium such as an IC chip mounted in a portable phone or the like.

The monitor unit 4 comprises a plurality of main monitors 9 for displaying information relating to the game (including image and the like). Though FIG. 1 shows a state that two main monitors 9 are aligned side-by-side, behind the main monitors 9, also arranged are two main monitors 9 in such a way that the display surfaces thereof face the opposite direction. The main monitors 9 are supported in a hanging state so as to pass over the field 5 obliquely to the longitudinal direction of the field 5. As the main monitor 9, a substantially plate-like flat panel display, such as a liquid crystal display, a plasma display, and an organic EL display is employed.

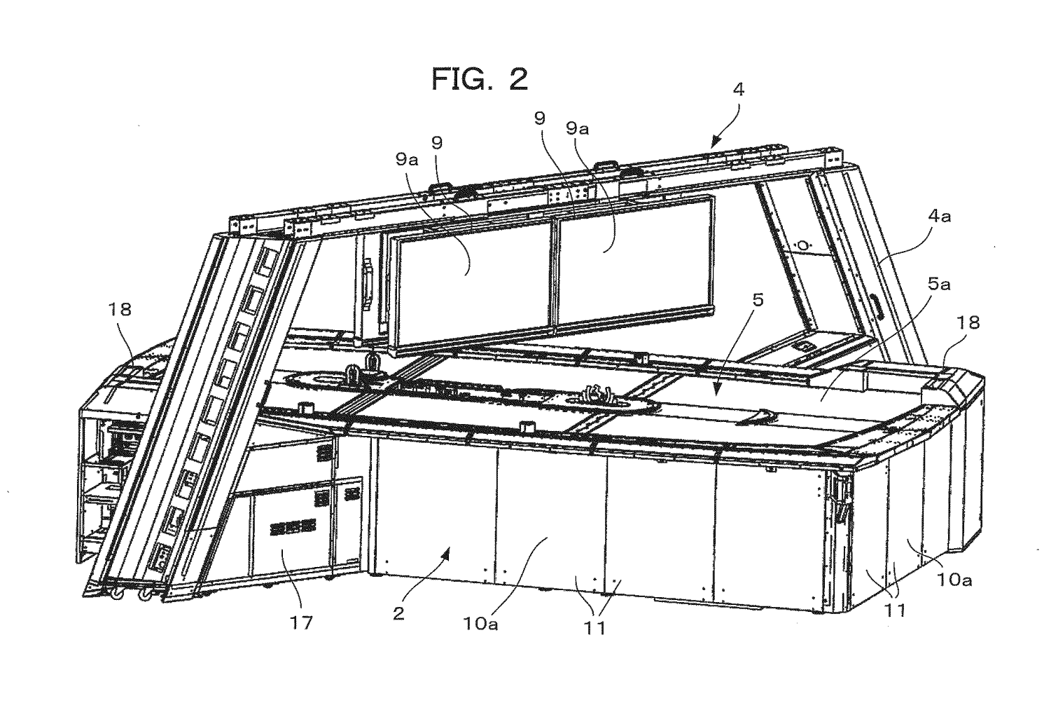

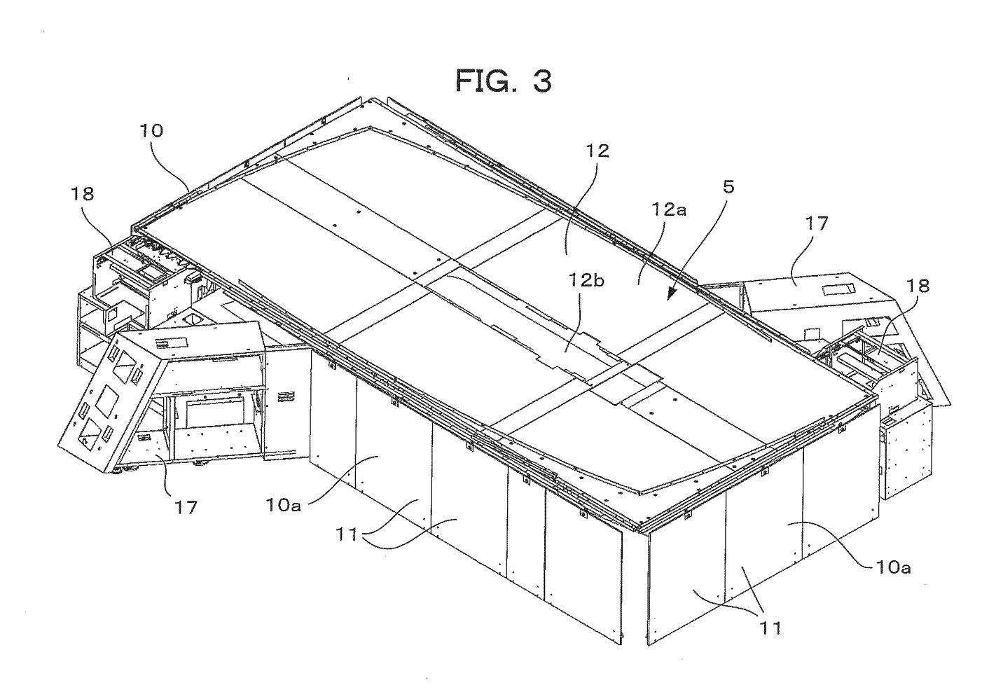

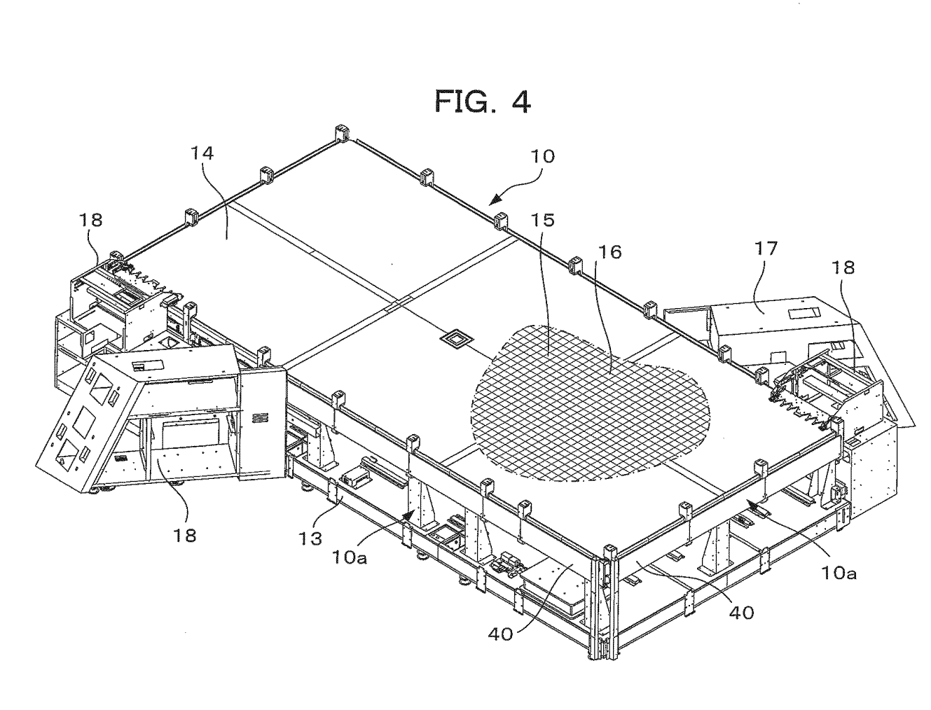

FIG. 2 shows a state that major portions of the filed unit 2 and the monitor unit 4 are shown by removing the station units 3 from the game machine 1. The field unit 2 has a chassis 10 as a major structure thereof. FIG. 3 shows a major portion of the chassis 10 in a state that a decorative panel and the other accessories are removed from the chassis 10. As apparent by FIGS. 2 and 3, the chassis 10 has a box-shaped structure which is a substantially cuboid, the side surfaces 10a of which are covered by side plates 11 respectively and the upper surface side of which is covered by a top plate 12. The field 5 is formed on the upper surface 12a of the top plate 12. In the top plate 12, formed is an opening portion 12b for housing the gate unit 8 (see, FIG. 3). FIG. 4 shows a state that the side plates 11 and the top plate 12 are removed from the chassis 10. Inside of the chassis 10, provided is a frame 13 constituting a frame of the chassis 10. The upper portion of the frame 13 is provided with a plate-like section plate 14. The section plate 14 is installed below the top plate 12 in parallel to the top plate 12. The upper surface of the section plate 14 is configured as the travel surface 15 of the self-propelling vehicle 7. The travel surface 15 is parallel to the upper surface 12a of the top plate 12 (see FIG. 5). A sensor 16 for detecting the position of the self-propelling vehicle 7 is provided to all over the travel surface 15. The details of the sensor 16 will be described later. Incidentally, in the outer circumference of the chassis 10, provided are a base 17 of the monitor support frame 4a and an electric charge unit 18 for charging up the self-propelling vehicle 7.

As shown in FIG. 5, the self-propelling vehicle 7 is disposed in space S existing between the travel surface 15 and the lower surface 12c of the top plate 12. The self-propelling vehicle 7 comprises a lower vehicle platform 20 and an upper vehicle platform 21. The lower vehicle platform 20 has a pair of left and right wheels 22 (only one side of them is shown in FIG. 5) contacting the travel surface 15, and rear and front supplementary wheels 23. As the lower vehicle platform 20 does not have a drive source, the wheels 22 and the supplementary wheels 23 are non derive wheels. Detected pieces 24 are provided at the backward and forward of the wheels 22 respectively. Each detected piece 24 is an object which is made of electric conductor such as metal, and should be detected by the sensor 16. For discriminating each of the front side and rear side of the self-propelling vehicle 7, the front detected piece 24 and the rear detected piece 24 may be different from each other in the size or the shape.

On the other hand, the upper vehicle platform 21 comprises a pair of left and right wheels 26 (only one side of them is shown in FIG. 5), rear and front supplementary wheels 27 and a drive unit 28 driving to rotate the wheels 26, the pair of wheels 26 contacting the lower surface 12c of the top plate 12 so as to be pressed to the lower surface 12c by a not-illustrated press mechanism built in between the vehicle platforms 20, 21. The wheels 26 are the drive wheels of the self-propelling vehicle 7. The drive unit 28 is configured so as to change as appropriate traveling direction and traveling speed, for example, by driving each of the pair of wheels 26 independently. Magnets 29 are provided at the backward and forward of the wheels 26 respectively. Those magnets 29 draw not-illustrated magnets or strong magnetic bodies built in a carriage 6a of the model 6. Thereby, the self-propelling vehicle 7 and the model 6 are coupled with each other through the top plate 12. Incidentally, though the sensor 16 is not illustrated in FIG. 5, all over of the travel surface 15 is covered by the detection portions of the sensor 16 actually.

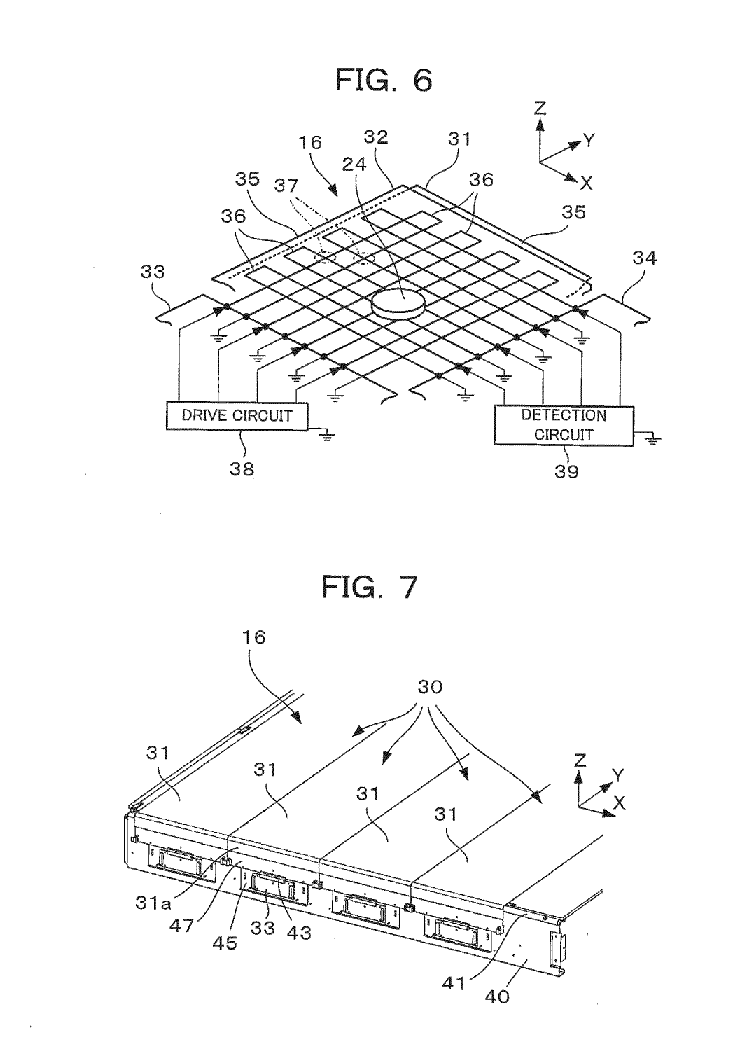

Next, the details of the sensor 16 will be described. As shown in FIG. 6, a pair of sheet-like detection portions 31, 32 and substrate portions 33, 34 combined with the detection portions 31, 32 respectively. Each of the detection portions 31, 32 has a construction that a lot of loop-like coils 36 are embedded in a base sheet 35 made of dielectric material, the coils being parallel to each other and arranged at constant intervals. The base sheet 35 is made of resin, and the coil 36 is formed by folding back parallelly a conductor line having a small wire diameter. Thereby, each of the detection portions 31, 32 has bendable flexibility. When it is defined that X direction is the longitudinal direction of the travel surface 15 of the chassis 10, Z direction is a direction perpendicular to the travel surface 15, and Y direction is perpendicular to both of the X and Z directions, one detection portion 31 is provided on the travel surface 15 so that the coils 36 of the detection portion 31 are aligned in the X direction, and the other detection portion 32 is overlapped on the one detection portion 31 so that the coils 36 of the detection portion 32 are aligned in the Y direction. Thereby, the coils 36 of the one detection portion 31 and the coils 36 of the other detection portion 32 are arranged so as to be perpendicular to each other, and at the intersection portion of them a cell portion 37 is formed. The gate unit 8 is hosed in the space S through the opening portion 12b of the top plate 12, and the portion below the opening portion 12b is also covered by the detection portions 31, 32.

To the substrate portion 33 corresponding to the one detection portion 31, a drive circuit 38 is mounted as an electric circuit component, the drive circuit 38 supplying alternating current to each coil 36. To the other detection portion 32, a detection circuit 39 is mounted as an electric circuit component, the detection circuit 39 detecting induced current or induced voltage generated in the coil 36. Hereinafter, the coil 36 of the one detection portion 31 is sometimes referred to as the transmitting-side coil 36, and the coil 36 of the other detection portion 32 is sometimes referred to as the receiving-side coil 36. The drive circuit 38 supplies alternating current to the transmitting-side coils 36 along with the direction X in series. Namely, by supplying current in series, with respect to the direction X, one end of transmitting-side coil 36 to the other end of transmitting-side coil 36, the travel surface 15 is scanned in the direction X. When the alternating current is supplied to the transmitting-side coil 36, electromagnetic coupling is generated at the cell portion 37 and induced current flows through the receiving-side coil 36. When the detected pieces 24 (see FIG. 5) are positioned on the detection units 31, 32, changed is a state of electromagnetic coupling of the cell portions 37 existing within a predetermined range the center of which is the detected piece 24. Thereby, with respect to the induced current or the induced voltage outputted from the receiving-side coil 36 (hereinafter, sometimes referred to as the output signal), the intensity is changed according to the distance up to the detected piece 24. By correlating each scanning position with respect to the direction X of each transmitting-side coil 36 and each position with respect to the direction Y of each receiving-side coil 36, it is possible to measure intensity distribution of output signal of each cell portion 37 on the travel surface 15. Further, it is possible to detect the position of the detected pieces 24 on the travel surface 15 based on the intensity distribution measured. The detected pieces 24 are provided to the self-propelling vehicle 7 having space therebetween with respect to the front-back direction. By specifying the detected pieces 24 of the same self-propelling vehicle 7 from the detection results of the detection circuit 39, it is possible to detect the position and direction on the travel surface 15 with respect to the self-propelling vehicle 7.

Next, the installation structure of the sensor 16 will be explained. The detection portion 31 including the transmitting-side coils 36 and the detection portion 32 including the receiving-side coils 36 are laid on all over the travel surface 15 by the same installation structure except vertical relation of them. Therefore, hereinafter, the installation structure will be described with respect to the transmitting side as an example. As shown in FIG. 7, the sensor 16 is configured in such a way that plural modules 30 are arranged side-by-side on the upper surface of section plate 14. Each module 30 is provided with the detection portion 31 and the substrate portion 33. The detection portion 31 provided to one module 30 is formed in the rectangular shape, the rectangular having an enough length to cross the upper surface of section plate 14 in the width direction thereof (the direction Y in FIG. 7). Incidentally, the coil 36 of the detection portion 31 is also extended in the longitudinal direction of the detection portion 31.

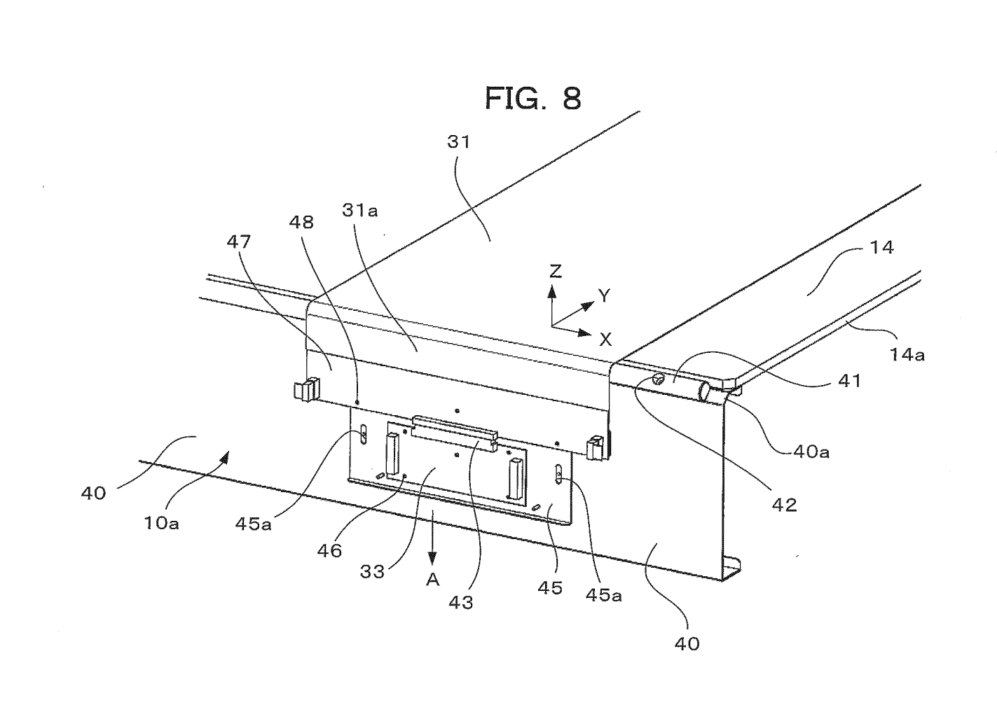

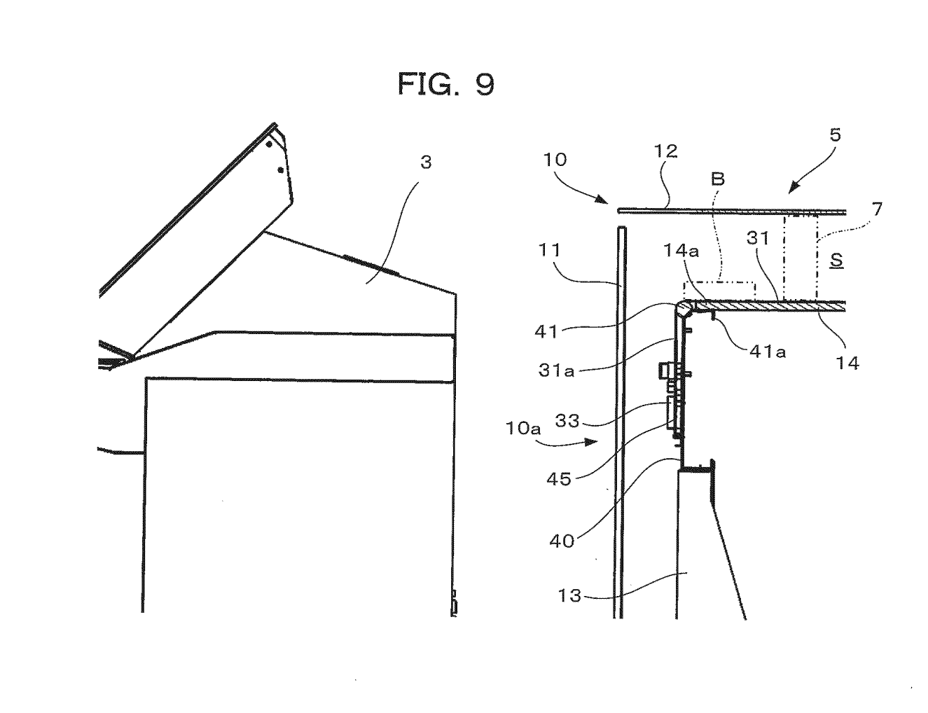

As described in detail in FIGS. 8 and 9, each metal plate 40 is attached to each side surface 10a of the chassis 10. The plate 40 is attached to the frame 13 so as to be arranged along a circumferential edge portion 14a of the section plate 14, and thereby, constitutes one portion of the chassis 10. As shown in FIG. 8, the section plate 14 is attached to the chassis 10 so that the circumferential edge portion 14a thereof overlaps a turndown portion 40a of each plate 40. On the turndown portion 40a of the plate 40, a guiding member 41 is provided so as to be located at the border between the circumferential edge portion 14a of the section plate 14 and the side plate 10a of the chassis 10, and the guiding member 41 is fixed by a bolt 42. The outer circumference of the guiding member 41 is formed in the rounded shape.

The end portion 31a of the detection portion 31 is bent toward the plate 40 side with wrapping the guiding member 41. The substrate portion 33 is connected with the bent end portion 31a of the detection portion 31 through the connector 43. While being physically connected with the base sheet 35 (see FIG. 6) of the detection portion 31 through the connector 43, the substrate portion 33 is electrically connected with each coil 36 of the detection portion 31 through the connector 43. Behind the substrate portion 33, provided is an attachment plate (an attachment member) 45 obtained by processing a metal plate. The substrate portion 33 is fixed to the surface of the attachment plate 45 using plural screws 46. To the end portion 31a of the detection portion 31, a metal subsidiary plate (a subsidiary member) 47 is provided so as to cover the base sheet 35. The subsidiary plate 47 is fixed to both of the attachment plate 45 and the detection portion 31 (more specifically, the base sheet 35) using plural screws 48. A pair of attachment holes 45a are formed in the attachment plate 45. Each of the attachment holes 45a has the long hole shape extending in a vertical direction. The attachment plate 45 is fixed to the chassis 10 by screwing un-illustrated attachment bolt in the plate 40 through each of the attachment holes 45a.

Although the illustration is omitted, the opposite end portion of the detection portion 31 is fixed to the chassis 10 by an appropriate attachment structure. For example, as with the end portion 31a of the substrate portion 33 side, the opposite end portion of the detection portion 31 is also bent toward the plate 40 side with wrapping the guiding member 41 and fixed to the plate 40 by using an attachment member similar to the subsidiary plate 47. Accordingly, by fixing the attachment plate 45 to the plate 40 in a state that a detection portion 31 is tensed with appropriate force generated by drawing the attachment plate 45 lower (the arrow A direction in FIG. 8), it is possible to put the detection portion 31 on the upper surface of the section plate 14 without slack. As the attachment plate 45 and the detection portion 31 are coupled with each other through the subsidiary plate 47, even if force is applied to the attachment plate 45, the force is never transmitted to the connector 43. Therefore, there is no possibility there could occur a trouble such as disconnection of the connector 43 caused by too much load at the moment of attaching the substrate portion 33.

As shown in FIG. 9, the substrate portion 33 attached to the plate 40 is concealed from the outside by the side plate 11 of the chassis 10. The station units 3 are arranged on a further outside of the side plate 11. The attachment position of the substrate portion 33 is set to a region which is included in the circumference of the chassis 10 and is covered by the station unit 3. Each station unit 3 is configured as a unit independent of the chassis 10 so as to separate from the chassis 10. Accordingly, if the station units 3 get removed from the chassis 10 and the side plates 11 get removed, it is possible to expose the substrate portions 33 along the circumference of the chassis 10. Thereby, it is possible to access easily to the substrate portion 33. As shown with an imaginary line B in FIG. 9, assumed that the substrate portions 33 are arranged so as to overlap the circumferential edge portion 14a of the section plate 14, it becomes not easy to access to the substrate portions 33 because of some obstacles such as the top plate 12. Moreover, as the space S is partially occluded by the substrate portions 33, the circumference of the space S existing between the top plate 12 and the section plate 14, that is, the entrance portion of the space S is narrowed. Thereby, an obstacle arises in the access to the inside of the space S. As apparent from FIG. 7, as the substrate portion 33 is provided to each of the plurality of modules 30, such inconvenience could occur at a lot of locations of the circumference of the chassis 10. On the other hand, as the self-propelling vehicle 7 has a height equal to the entire length of the space S, in a case the entrance portion is narrowed by the substrate portions 33, the self-propelling vehicle cannot be got out of and put into the space S in a upright state, and it is required to incline the self-propelling vehicle to the horizontal direction. However, it is hard to execute such an operation in the narrow space S. However, according to the present embodiment, as the substrate portions 33 exist on the side wall 10a, all inconveniences above mentioned are eliminated. Therefore, it is possible to significantly enhance work efficiency at the moment of maintenance of the game machine or the like.

Next, the correction of output signal of the sensor 16 will be described. As mentioned above, the sensor 16 detects the position of the detected body 24 of the self-propelling vehicle 7 by measuring the intensity distribution of output signal appropriate for the state of electromagnetic coupling of the cross portion of the coils 36 of the detection portions 31, 32, that is, the cell portion 37. However, at each cell portion 37 of the sensor 16, the state of electromagnetic coupling could change and the affection thereof appears in the output signal, not only because of the detected body 24, but also in a case an electric conductor exists around the cell portion 37. Around the section plate 14 of the chassis 10, some components made of electric conductor, such as the gate unit 8 and the plate 40, are arranged appropriately. Then, the affections of those components appear in the intensity distribution of output signal outputted by the sensor 16. Moreover, the affection is different depending on each game machine 1, or there is a possibility that the affection changes with time. Then, in order to improve the position detection accuracy of the self-propelling vehicle 7 by the sensor 16, required is the following processes of: measuring the intensity distribution of output signal in a state that the self-propelling vehicle 7 does not exist and storing the intensity distribution as correction data; and, in a case of detecting the position of the self-propelling vehicle 7, calculating an accurate intensity distribution by subtracting the correction data from the data of intensity distribution detected by the sensor 16 (this process is referred to as the correction process).

However, for removing the self-propelling vehicle 7, disassembly operation of the game machine 1 is necessary, and for generating the correction data, at least it is necessary to assemble the chassis 10 and all of the accessories thereof. The operation like this is troublesome. Then, with respect to the game machine 1, the mentioned inconvenience could be eliminated by generating the correction data without removing the self-propelling vehicle 7 as follows.

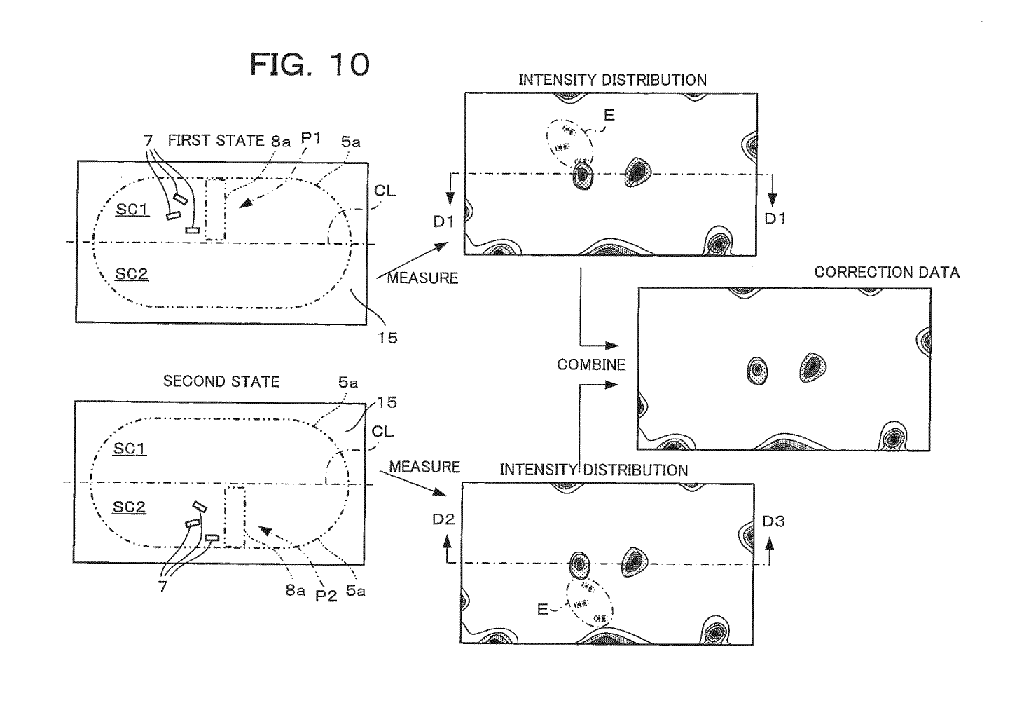

FIG. 10 shows a simple overview of procedures of generating the correction data in the game machine 1. In the game machine 1, in a case that the travel surface 15 is sectioned into the first region SC1 and the second region SC2 by a central line CL as a border line, the central line CL extending in the longitudinal direction of the course 5a, a first state that the self-propelling vehicles 7 gather in the first region SC1 and a second state that the self-propelling vehicles 7 gather in the second region SC2 selectively occur. For example, the first state occurs in a case that the gate 8a is controlled to be located at the position P1 for the start and all of the self-propelling vehicles 7 (FIG. 10 shows only 3 vehicles as an example) gather to house the models 6 into the gate 8a, and the second state occurs in a case that the gate 8a is controlled to be located at the position P2 and all of the self-propelling vehicles 7 gather to house the models 6 into the gate 8a. In the first state, no self-propelling vehicle 7 exists in the second region SC2, and in the second state, no self-propelling vehicle 7 exists in the first region SC1. Then, generated is the correction data relating to the intensity distribution of whole of the travel surface 15 by the following processes: the intensity distribution of output signal of the sensor 16 is measured in each of the first state and the second state; the intensity distribution of the second region SC2 which was measured in the first state (the distribution within a region shown by arrows D1-D1) and the intensity distribution of the first region SC1 which was measured in the second state (the distribution within a region shown by arrows D2-D2) are extracted; and the intensity distributions extracted are combined.

In FIG. 10, the intensity distribution is shown so that the higher the signal intensity is, the higher the color intensity is (the color verges to black). Here, with respect to height of the intensity, it is defined that as the cell portion 37 is closer to the electric conductor, the intensity becomes higher. With respect to the measurement in each of the first state and the second state, the intensity distribution obtained includes a portion indicating the intensity corresponding to the detected body 24 of the self-propelling vehicle 7, as shown by a region E. However, in the region to be used for the combination to generate the correction data, there is no portion corresponding to the detected body 24 of the self-propelling vehicle 7. Accordingly, the correction data that is the intensity distribution obtained after the combination is substantially equivalent to the intensity distribution of a case that all of the self-propelling vehicles 7 are removed from the travel surface 15 and the intensity is measured. Accordingly, when the correction data is subtracted from the data of signal intensity distribution of the sell portions 37 measured at the moment of detecting the position of the self-propelling vehicle 7, it is possible to detect accurately the position of the detected body 24 of the self-propelling vehicle.

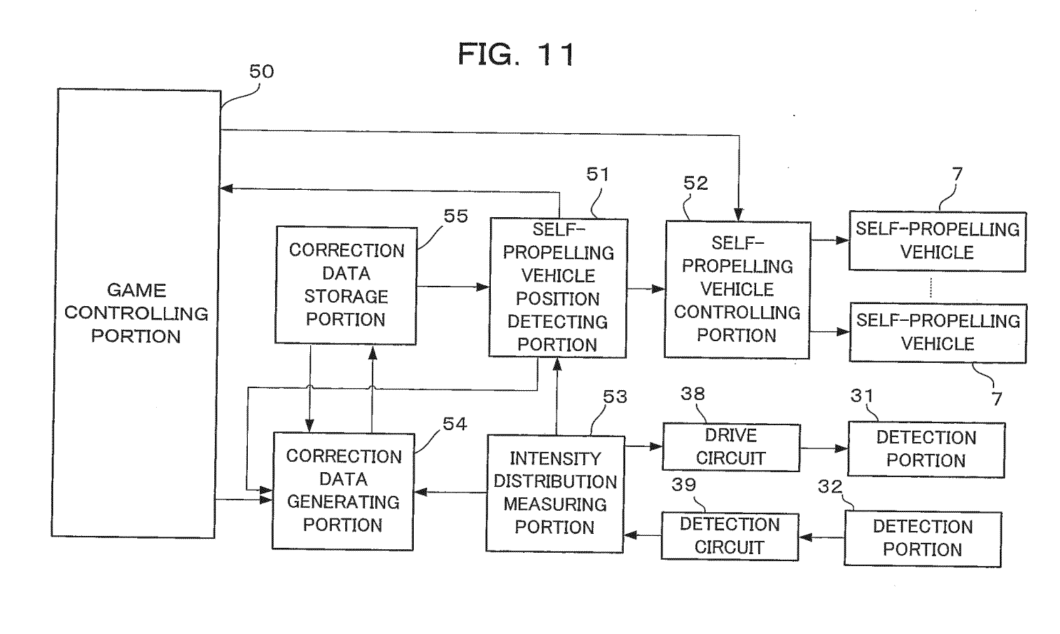

FIG. 11 is a functional block diagram showing a control system of the game machine 1 mainly with respect to a portion relating to the mentioned generation of the correction data. The control system 1 of the game machine 1 is provided with a game controlling portion 50, a self-propelling vehicle position detecting portion 51, a self-propelling vehicle controlling portion 52, an intensity distribution measuring portion 53, and a correction data generating portion 54. Each of the portions 51 to 54 is a logical device which is realized by a combination of a computer unit as hardware provided to the game machine 1 and a predetermined computer program as software. Further, the control system of the game machine 1 is provided with a correction data storage portion 55 storing the correction data relating to the intensity distribution of the sensor 16 mentioned.

The game controlling portion 50 executes calculation and operation control necessary for progress of a horse race game on the field 5. For example, the game controlling portion 50 calculates sequentially a target position and the like of each model 6 before a race, during a race, and after a race in accordance with a predetermined condition, and controls to switch the position of the gate unit 8 as necessary. The self-propelling vehicle position detecting portion 51 corrects intensity distribution based on intensity distribution data measured by the sensor 16 and the correction data stored in the correction data storage portion 55, and detects the current position of the self-propelling vehicle 7 based on the intensity distribution data corrected. The self-propelling vehicle controlling portion 52 calculates operation control parameters of a drive unit 28 (see FIG. 5) necessary to make each self-propelling vehicle 7 travel to a target position, such as driving speed and driving direction of the left and right wheels 26, based on a target position of each self-propelling vehicle 7 indicated sequentially from the game controlling portion 50 and the current position of each self-propelling vehicle 7 detected by the self-propelling position detecting portion 51 (hereinafter, sometimes referred to as the position information), and notifies each self-propelling vehicle 7 of the calculation result. The notification from the self-propelling vehicle controlling portion 52 to the self-propelling vehicle 7 is performed by using a wireless system as one example. The drive unit 28 of self-propelling vehicle 7 drives the wheels 26 in accordance with the parameters notified from the self-propelling vehicle controlling portion 52.

While instructing the drive circuit 38 of the sensor 16 to scan using the receiving-side coils 36, the intensity distribution measuring portion 53 obtains the output signal of each receiving-side coil 36 through the detection circuit 39, and correlates the scan position of the receiving-side coil 36 to the position of the receiving-side coil 36 to calculate the distribution of signal intensity of each cell portion 37. The intensity distribution measured by the intensity distribution measuring portion 53 is outputted to the correction data generating portion 54 as necessary, while being outputted sequentially to the self-propelling vehicle position detecting portion 51. The correction data generating portion 54 generates the correction data of the sensor 16 based on an instruction from the game controlling portion 50, and updates original correction data stored in the correction data storage portion 55 by the correction data obtained newly. For the correction process by the correction data generating portion 54, used are the measuring result by the intensity distribution measuring portion 53, the detection result by the self-propelling vehicle position detecting portion 51, and the correction data originally stored in the correction data storage portion 55.

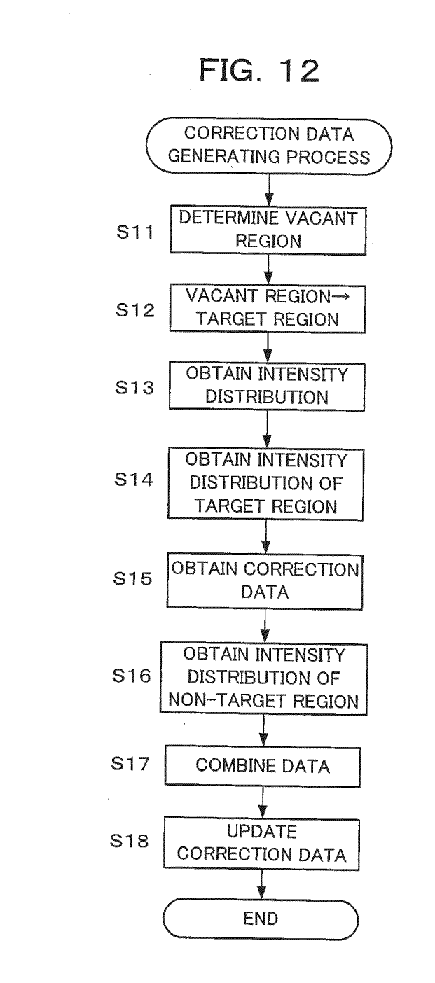

The correction data is generated by the correction data generating portion 54 at a time when, while the game controlling portion 50 is controlling the operation of self-propelling vehicle 7 for an aim other than an aim to generate of correction data, either the first state or the second state occurs as the control result. When either one of the states occurs, the game controlling portion 50 instructs the correction data generating portion 54 to generate the correction data. In response to the instruction, the correction data generating portion 54 starts correction data generating process shown in FIG. 12. Hereinafter, the procedure in the correction data generating process will be described.

When the correction data generating process is started, the correction data generating portion 54, first, determines whether either the region SC1 or the region SC2 on the travel surface 15 is a vacant region where no self-propelling vehicle 7 exists, based on the position information detected by the self-propelling vehicle position detecting portion 51 (step S11). Next, the correction data generating portion 54 sets the vacant region as a target region of process of this time (step S12), and subsequently, obtains the intensity distribution data from the intensity distribution measuring portion 53 (step S13). Further, the correction data generating portion 54 obtains from the intensity distribution data obtained from the intensity distribution measuring portion 53, the intensity distribution data of the target region, that is, the vacant region which is either one of the regions SC1 and SC2 (step S14). Subsequently, the correction data generating portion 54 obtains the correction data from the correction data storage portion 55 (step S15), and obtains from the correction data, the intensity distribution of non-target region, that is, the other one of the regions SC1 and SC2 (step S16). After that, the correction data generating portion 54 combines the intensity distribution data obtained at step S14 and the intensity distribution data obtained at step S16 to generate correction data (step S17), and by overwriting the correction data storage portion 55 by the correction data generated, updates the correction data in the storage portion 55 (step S18). After that, the correction data generating portion 54 ends the process of this time. By implementing the above process appropriately at an appropriate time when either the first region SC1 or the second region SC2 becomes the vacant region, the correction data stored in the correction data storage portion 55 is updated repeatedly. Thereby, it is possible to improve the position detection accuracy by the sensor 16.

In the above example, the correction data generating process is implemented in time with the chance that either the first state or the second state occurs while the game controlling portion 50 is controlling the progress of the game. However, the process shown in FIG. 12 may be implemented at an appropriate chance when either one of the first state and the second state occurs. For example, in the game machine 1, when remaining capacity of rechargeable battery built in the self-propelling vehicle 7 decreases up to a predetermined level, implemented is a control to make the self-propelling vehicle 7 travel up to the position of the electric charge unit 18 and to take a weak rechargeable battery into the electric charge unit 18 and charge up the rechargeable battery. In a case that such process is implemented only at one electric charge unit 18 of either one of the first region SC1 and the second region SC2 on the travel surface 15, the process shown in FIG. 12 may be implemented by setting the other region as the target region. Alternatively, by the game controlling portion 50 or the self-propelling vehicle control-ling portion 52, the operation of self-propelling vehicle 7 may be controlled intentionally so that either the first state or the second state occurs, and in liaison with this control, the process shown in FIG. 12 may be implemented.

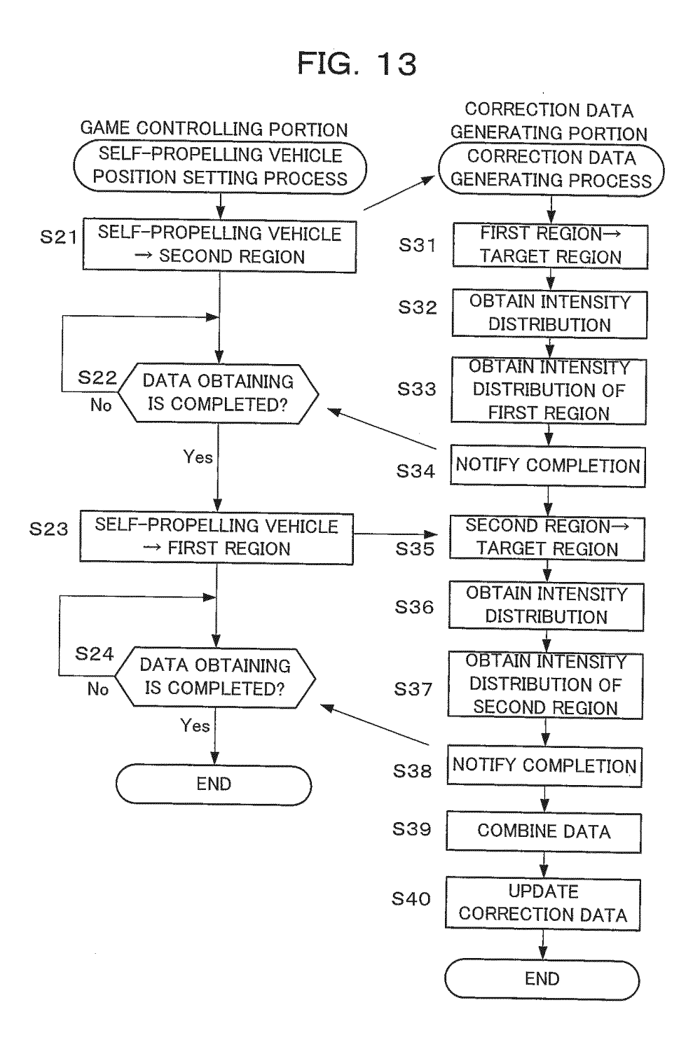

Further, by the game controlling portion 50 or the self-propelling controlling portion 52, the operation of self-propelling vehicle 7 may be controlled so that the first state or the second state occurs in series for an aim to generate the correction data, and the correction data may be generated by obtaining the intensity distribution data of each of the first region SC1 and the second region SC2 in series in time with occurrence of each state. FIG. 13 shows a process as one example of this case. In FIG. 13, applied is an example where the game controlling portion 50 implements a self-propelling vehicle position setting process for setting intentionally the position of self-propelling vehicle 7, and in liaison with this process, the correction data generating portion 54 implements the correction data generating process. However, the self-propelling vehicle position setting process can be implemented by the self-propelling vehicle controlling portion 52.

In the example of FIG. 13, the game controlling portion 50 starts the self-propelling vehicle position setting process when determining that there is no problem even if the position control of self-propelling vehicle 7 is implemented for an aim to generate the correction data. First, while instructing the self-propelling vehicle controlling portion 52 so that all of the self-propelling vehicles 7 gather in the second region SC2, the game controlling portion 50 instructs the correction data generating portion 54 to start the correction data generating process (step S21). Subsequently, it is determined whether a completion of data obtaining has been notified from the correction data generating portion 54 (step S22). When the completion is notified, while instructing the self-propelling vehicle controlling portion 52 so that all of the self-propelling vehicles 7 gather in the first region SC1, the game controlling portion 50 also notifies the instruction to the correction data generating portion 54 (step S23). Subsequently, the game controlling portion 50 determines whether a completion of data obtaining is notified from the correction data generating portion 54 (step S24). When the completion has been notified, the game controlling portion 50 ends the self-propelling vehicle position setting process.

While, the correction data generating portion 54 sets the first region SC1 to a target region of process (step S31). In this case, the process of step S31 is deferred or the process of step S32 is not started until it is confirmed that no self-propelling vehicle 7 exists in the first region SC1 based on the position information from the self-propelling position vehicle detecting portion 51. Next, the correction data generating portion 54 obtains intensity distribution data from the intensity distribution measuring portion 53 (step S32), and subsequently, from the intensity distribution data obtained, obtains intensity distribution data of the target region, that is, the first region SC1 (step S33). Next, the correction data generating portion 54 notifies the completion of data obtaining with respect to the first region SC1 to the game controlling portion 50 (step S34). After that, the correction data generating portion 54 sets the second region SC2 to a target region of process on the condition that the instruction of step S23 is transmitted from the game controlling portion 50 (step S35). In this case, the process of step S35 is deferred or the process of step S36 is not started until it is confirmed that no self-propelling vehicle 7 exists in the second region SC2 based on the position information from the self-propelling position detecting portion 51.

Next, the correction data generating portion 54 obtains the intensity distribution data from the intensity distribution measuring portion 53 (step S36), and subsequently, from the intensity distribution data obtained, obtains intensity distribution data of the target region, that is, the second region SC2 (step S37). After that, the correction data generating portion 54 notifies the completion of data obtaining with respect to the second region SC2 to the game controlling portion 50 (step S38). After that, the correction data generating portion 54 combines the intensity distribution data obtained at step S33 and the intensity distribution data obtained at step S37 to generate the correction data (step S39). By overwriting the correction data storage portion 55 by the correction data generated, the correction data generating portion 54 updates original correction data stored in the storage portion 55 (step S40). After that, the correction data generating portion 54 ends the correction data generating process of this time. In this way, the intensity distribution data of the first region SC1 and the intensity distribution data of the second region SC2 are obtained in series, and the correction data of whole of the travel surface is updated in a lump.

In the above embodiment, the travel surface 15 of the section plate 14 corresponds to a travel region of a self-propelling vehicle as a traveling body. The self-propelling vehicle position detecting portion 51 corresponds to a position detecting device, and the correction data generating portion 54 corresponds to the correction data generating device, the combination of the game controlling portion 50 and the self-propelling vehicle controlling portion 52 corresponds to a traveling body controlling device. The game controlling portion 50 or the self-propelling vehicle controlling portion 52 functions as a traveling body position setting device by implementing the processes of steps S21 to S24 in FIG. 13. Further, step S14 in FIG. 2 and steps S33 and S37 in FIG. 13 correspond to a procedure of obtaining output from a sensor with respect to the vacant region. Step S17 in FIG. 12 and step S39 in FIG. 13 correspond to a procedure of generating the correction data.

In the above embodiment, the travel surface 15 for the self-propelling vehicle as the traveling body is sectioned into the first region SC1 and the second region SC2. However, the travel region of the traveling body may be sectioned into 3 regions or more. In this case, when a region changes from a region where any traveling body exists to a vacant region where no traveling body exists in relays, the output by the sensor 16 relating to the vacant region is obtained, and if the output obtained is combined with output by the sensor 16 relating to the other region when the other region is the vacant region, the correction data can be obtained. Incidentally, here, the term “in relays” means that the region to become the vacant region changes in turns as time passes.

To one portion or whole of the travel surface 15 as the travel region of the traveling body, incline or undulation may be provided. Each cell portion 37 of the sensor 16 which is arranged along the travel region in a two-dimensional manner can be applied to the present invention. For example, even if there is incline or undulation in the travel surface 15, in a case that the cell portions 37 are arranged along the incline or the undulation, the arrangement is included in the “two-dimensional manner”.

In the above embodiment, plural station units 3 are arranged around the chassis 10, the present invention does not always require the station units 3. The game machine to which the present invention is applied is not limited to an example of game machine which makes a model representing a racehorse travel on a filed. The model may be formed so as to represent a vehicle or other various kinds of shapes. The traveling body is not limited to an example of traveling body which travels on the upper surface of the section plate as the travel surface. A traveling body which travels within a predetermined travel region in the game machine can be employed. Further, the game machine of the present invention is not limited to an example of game machine which comprises the model traveling on the top plate by following the traveling body. For example, the present invention can be applied to a game machine where one portion or whole of a transparent top plate is provided so that travel of traveling body is observed through the top plate. Additionally, the game machine of the present invention is not limited to an example of game machine which is provided with two plate-like members which are the top plate and the section plate.

A detection method by a sensor is not limited to an example that change of state of electromagnetic coupling is detected, the change being provoked by an approach of the detected body made of electric conductor to the cell portion. As long as a sensor can measure a physical state in a quantitative way in such a way that, when a physical state of the cell portion changes depending on a positional relation with the detected body made of electric conductor, the sensor can output the change of physical state by converting the change into electric current, electric voltage, or the like, the present invention can be applied appropriately to the sensor. For example, even if a pressure type sensor which detects a change of deflection caused by the traveling body's own weight or the like, the present invention can be applied at the moment when the detection data for the pressure type sensor is generated. Alternatively, an optical sensor may be used, the optical sensor detecting a change of received light intensity of light receiving element provided to each cell portion. A sensor is not limited to an example of sensor which has a sheet-like detection portion. Each cell may be provided so as to be embedded in the section plate.

What is claim is:

1. A game machine comprising:
a traveling body capable of traveling along a predetermined travel region;
a sensor capable of outputting an output signal corresponding to a change of physical state of each of a plurality of cell portions which are arranged two-dimensionally along the travel region, the physical state changing depending on positional relation to the traveling body; and
a position detecting device that is configured to detect a position of the traveling body based on the output signal by the sensor, wherein
the game machine further comprising a correction data generating device that is configured to,
when each of a plurality of regions, which the travel region is sectioned into, changes from a region where the traveling body exists to a vacant region where no traveling body exists in relays, obtain output signal by the sensor relating to the vacant region, and generate correction data for the output signal relating to a whole of travel region by combining together the output signal of each vacant region obtained.

2. The game machine according to claim 1, further comprising a traveling body controlling device that is configured to control operations of the traveling body so as to calculate an aim position of the traveling body and make the traveling body to travel to the aim position, wherein
the correction data generating device is configured to obtain the output signal by the sensor relating to the vacant region when any one of the plurality of regions becomes the vacant region, as a result of control by the traveling body controlling device to operate the traveling body for an aim other than an aim to generate the correction data.

3. The game machine according to claim 1, further comprising a traveling body controlling device that is configured to control operations of the traveling body so as to calculate an aim position of the traveling body and make the traveling body to travel to the aim position, wherein
the traveling body controlling device further comprises a traveling body position setting device that is configured to control operations of the traveling body so that each of the plurality of regions becomes the vacant region in series for an aim to generate the correction data, and
the correction data generating device is configured to obtain the output signal by the sensor relating to each vacant region, each time when the vacant region switches by control of the traveling body position setting device.

4. The game machine according to claim 1, further comprising a chassis including a top plate and a section plate provided at a lower surface side of the top plate so as to make space, wherein
an upper surface of the section plate is set as the travel region of the traveling body, and the plurality of cell portions of the sensor are arranged two-dimensionally along the upper surface of the section plate.

5. The game machine according to claim 4, wherein
a plurality of self-propelling vehicles capable of traveling along the upper surface are arranged as the traveling body, and
on an upper surface of the top plate, a plurality of models coupled with the plurality of self-propelling vehicles are arranged respectively so that each of the plurality of models travels on the upper surface of the top plate following travel of the traveling body.

6. The game machine according to claim 2, further comprising a chassis including a top plate and a section plate provided at a lower surface side of the top plate so as to make space, wherein
an upper surface of the section plate is set as the travel region of the traveling body,
the plurality of cell portions of the sensor are arranged two-dimensionally along an upper surface of the section plate,
on the upper surface of the section plate, a plurality of self-propelling vehicles capable of traveling along the upper surface are arranged as the traveling body,
on an upper surface of the top plate, a plurality of models coupled with the plurality of self-propelling vehicles are arranged respectively so that each of the plurality of models travels on the upper surface of the top plate following travel of the traveling body, and
the traveling body controlling device is capable of calculating an aim position of each of the plurality of self-propelling vehicles so that progressed is a race game where each of the plurality of models is made to compete with each other.

7. The game machine according to claim 6, wherein
in a case the upper surface of section plate is sectioned into a first region and a second region as the plurality of regions, the traveling body controlling device controls operations of each self-propelling vehicle so that a first state that the plurality of self-propelling vehicles gathers in the first region and a second state that the plurality of self-propelling vehicles gathers in the second region occur selectively, and
the correction data generating device sets, while setting the second region as the vacant region in the first state and obtaining the output signal by the sensor relating to the second region, the first region as the vacant region in the second state and obtains the output signal by the sensor relating to the first region, and combines the output signal by the sensor relating to the first region and the output signal by the sensor relating to the second region to generate the correction data.

8. The game machine according to claim 1, wherein
the traveling body is provided with a detected body using electric conductor, and
the sensor is capable of outputting a signal corresponding to change of state of electromagnetic coupling provoked by approach of the electric conductor to each of the plurality of cell portions, as the signal corresponding to the change of the physical state.

9. A method of generating sensor correction data of a game machine comprising: a traveling body capable of traveling along a predetermined travel region; a sensor capable of outputting an output signal corresponding to a change of physical state of each of a plurality of cell portions which are arranged two-dimensionally along the travel region, the physical state changing depending on positional relation to the traveling body; and a position detecting device that is configured to detect a position of the traveling body based on the output signal by the sensor, the method including the steps of:
obtaining output signal by the sensor relating to a vacant region where no traveling body exists, when each of a plurality of regions, which the travel region is sectioned into, changes from a region where the traveling body exists to the vacant region in relays, and
generating correction data for the output signal relating to a whole of travel region by combining together the output signal of each vacant region obtained.
